(19) United States
(12) Patent Application Publication
(10) Pub. No.: US 2012/0086846 A1
(43) Pub. Date: Apr. 12, 2012

(54) Interface system of an image-capturing device

(75) Inventors: Andy Ying-Guey Fuh, Tainan City (TW); Cheng-Kai Liu, Taipei City (TW)

(73) Assignee: National Cheng Kung University, Tainan City (TW)

(21) Appl. No.: 13/064,511

(22) Filed: Mar. 30, 2011

(30) Foreign Application Priority Data
Oct. 6, 2010 (TW) 099133996

(51) Int. Cl. H04N 5/222

(52) U.S. Cl. 348/333.01; 348/E05.022

(57) ABSTRACT

An interface system of an image-capturing device is disclosed, which is set on a hand-held image-capturing device. The interface system of an image-capturing device includes a display unit, a touch sensor unit, and a control unit. The display unit displays a variety of setting pictures of the image-capturing device. The touch sensor unit senses a touch of a user so as to change the setting pictures displayed on the display unit. The control unit is connected with the display unit and the touch sensor unit, for controlling the operation of the image-capturing device. The disclosed interface system of an image-capturing device enables the user to adjust various kinds of exposure parameters quickly and intuitively.

### CROSS REFERENCE TO RELATED APPLICATION

This application claims the benefits of the Taiwan Patent Application Serial Number 99133996, filed on Oct. 6, 2010, the subject matter of which is incorporated herein by reference.

### BACKGROUND OF THE INVENTION

1. Field of the Invention

The present invention relates to an interface system and, more particularly, to an interface system suitably for use in an image-capturing device.

2. Description of Related Art

Currently, accompanied by the development and progress improving of technology, digital electronic products become more and more popular. Take a digital SLR (Single Lens Reflex) or digital MIL (Mirrorless Interchangeable Lens) camera as an example, currently; the latest models of the digital SLR or MIL camera have developed toward the small-size design. Such kind of development affects the interface system of camera operation. Thus, the functions that are usually used in taking pictures by a camera, such as the ISO value, the exposure compensation value, the white balance, even the status adjustment of continuous shooting, can all be adjusted directly at the body of camera.

However, some of the most popular products in the market, such as Nikon D5000/D3000, Canon 550D, Pentax KX, Olympus EP-2/EPL-1, Panasonic GF1/G2/G10 and Sony etc., which are an entry-level SLR (Single Lens Reflex) camera or MIL (Mirrorless Interchangeable Lens) camera, must adjust all of the afore-mentioned parameters through the process of entering the Menu list, because there is no another display screen disposed on the top side of the camera, as shown in FIG. 1. This kind of parameter adjustment process is comparably time-consuming, and not in consistent with the professional usage. In addition, the user must memorize the locations of parameter columns in advance. However, some cameras of the sub-professional model, such as Canon 7D/5D2 etc., has set another display screen on the top side thereof, for the users to adjust the related parameters of exposure. However, due to the lack of another display screen on the top side of the camera for displaying the related parameters of exposure, the users can only determine the present values of the related parameters of exposure through the display screen disposed on the back side of the camera. This kind of parameter adjustment process makes the users difficult to control the present values of the related parameters of exposure, and the power consumption of the camera will be comparably high, as the users must turn on the display screen frequently to check the related parameter of exposure. A high-level convenient digital camera, such as Nikon P7000, Canon G11, etc., has set up many wheels on the top side of the camera, for fast adjusting the related parameters of exposure as above mentioned, and it makes the interface of the camera look too complicated; due to the same issue, the lack of the display screen to display the related parameters of exposure, the users can only access the related parameters of exposure from the display screen disposed on the back side of the camera, and this orientation makes users difficult to control the present values of the related parameters of exposure of the camera. Also, the power consumption will be high due to frequently turning operation of the display screen for determining the related parameter of exposure.

The present invention aims to design a hand-held image-capturing device (Digital Camera) that makes the users be capable of adjusting the related parameters of exposure fast and intuitively, to integrate common related parameters of exposure together to improve the adjusting process of the related parameters of exposure, and to overcome the problem of slow operation speed of currently entry level digital SLR (Single Lens Reflex) camera, digital MIL (Mirrorless Interchangeable Lens) camera and high level convenient digital camera, while, making the users to adjust the related parameters of exposure easily and decreasing the power consumption of the camera.

### SUMMARY OF THE INVENTION

The object of the present invention is to provide an interface system of an image-capturing device, which enables users to adjust the operation parameters related to image-capturing fast and intuitively by integrating common related parameters of exposure together, thus letting users to control the related parameters of exposure easily, and also reducing the power consumption of the camera.

To achieve the object, the interface system of an image-capturing device of the present invention is installed on a hand-held image-capturing device and comprises: a display unit, for displaying a variety of setting pictures of the image-capturing device, each of the variety of setting pictures including a plurality of setting value graphs; a touch sensor unit, installed in proximity to the display unit, for sensing a touch of a user so as to change the setting pictures of the image-capturing device displayed on the display unit, and to select a setting value graph in the setting picture; and a control unit, connected with the display unit and the touch sensor unit, for controlling the operation of the image-capturing device. Preferably, the display unit is a bi-stable display unit.

The display unit is in a circular shape and the touch sensor unit is circularly disposed on a peripheral portion of the circular display unit. The display unit is an LCD, an electronic ink display, a plasma display or a cholesterol-type LCD. Besides, the touch sensor unit selects the plurality of setting value graphs displayed on the display unit by sensing a moving touch and the direction of movement of the moving touch.

As the touch sensor unit senses a one-point touch of the user, the control unit drives the display unit to display a first setting picture including a plurality of first setting value graphs for selection; as the touch sensor unit senses a two-point touch of the user, the control unit drives the display unit to display a second setting picture including a plurality of second setting value graphs for selection; and as the touch sensor unit senses a three-point touch of the user, the control unit drives the display unit to display a third setting picture including a plurality of third setting value graphs for selection.

The two-point touch represents that the touch sensor unit senses a touch by two fingers of the user simultaneously, and the three-point touch represents that the touch sensor unit senses a touch by three fingers of the user simultaneously. The two-point touch represents that the touch sensor unit senses two continuous touches in a short time-interval and the three-point touch represents that the touch sensor unit senses three continuous touches in a short time-interval.

Preferably, the first setting picture displayed on the display unit is a display picture of an operating mode. The second setting picture displayed on the display unit is a display picture of ISO vale adjustment. The third setting picture displayed on the display unit is a display picture of exposure compensation value.

Other objects, advantages, and novel features of the invention will become more apparent from the following detailed description when taken in conjunction with the accompanying drawings.

### BRIEF DESCRIPTION OF THE DRAWINGS

FIG. 1 is a schematic diagram displaying the operation of the conventional camera;

FIG. 2 is a three-dimensional perspective view of a hand-held image-capturing device according to a preferred embodiment of the invention;

FIG. 3 is a schematic diagram of the interface system of an image-capturing device according to a preferred embodiment of the invention;

FIG. 4(A) is a schematic diagram displaying an initial display picture on the display unit of the hand-held image-capturing device according to a preferred embodiment of the invention;

FIG. 4(B) is a schematic diagram displaying a display picture on the display unit of the hand-held image-capturing device according to a preferred embodiment of the invention, as the power is turned on;

FIG. 4(C) is a schematic diagram displaying a first setting picture on the display unit of the hand-held image-capturing device according to a preferred embodiment of the invention;

FIG. 4(D) is a schematic diagram displaying a second setting picture on the display unit of the hand-held image-capturing device according to a preferred embodiment of the invention;

FIG. 4(E) is a schematic diagram displaying a third setting picture on the display unit of the hand-held image-capturing device according to a preferred embodiment of the invention; and

FIG. 4(F) is a schematic diagram displaying a display picture of current time and date on the display unit of the hand-held image-capturing device according to a preferred embodiment of the invention.

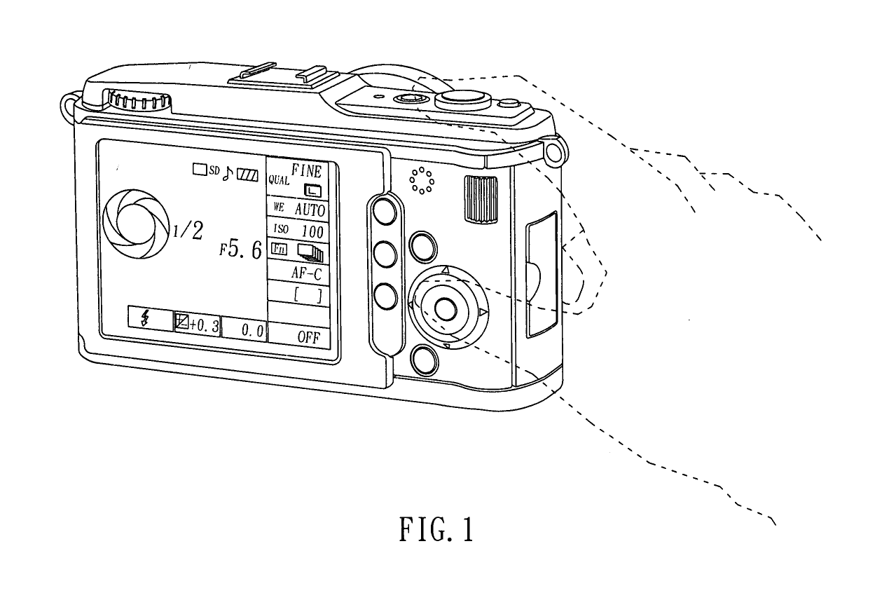

### DETAILED DESCRIPTION OF THE PREFERRED EMBODIMENT

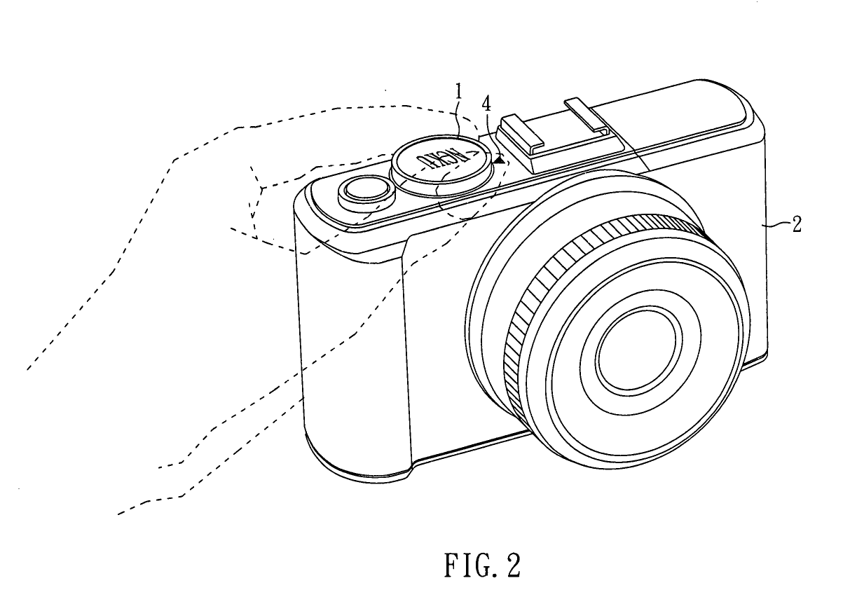

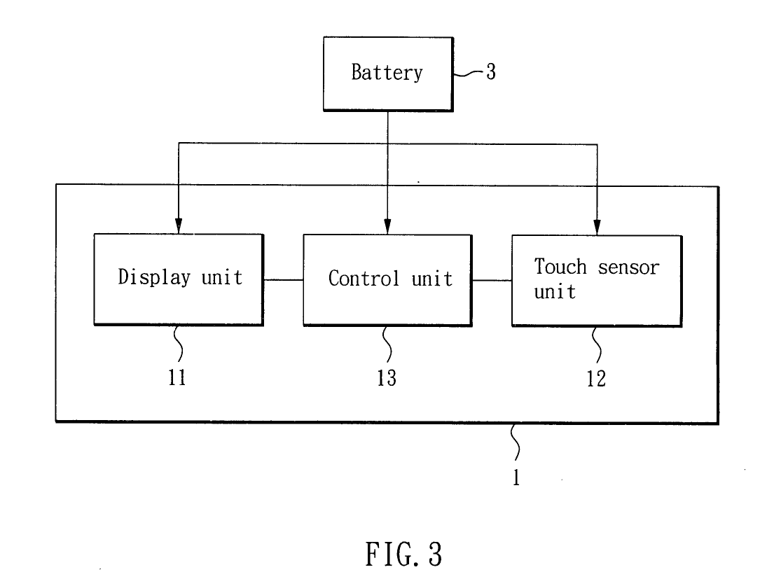

Please refer to FIG. 2 and FIG. 3 together. FIG. 2 is a three-dimensional perspective view of a hand-held image-capturing device according to a preferred embodiment of the invention, and FIG. 3 is a schematic diagram of the interface system of an image-capturing device according to a preferred embodiment of the invention. As shown in the figures, an interface system 1 of an image-capturing device of the present invention is installed on a hand-held image-capturing device 2. In the present embodiment, the hand-held image-capturing device 2 is a digital camera or a video camera recorder. The interface system 1 includes a display unit 11, a touch sensor unit 12 and a control unit 13, wherein the control unit 13 is connected with the display unit 11 and the touch sensor unit 12. Besides, the display unit 11, the touch sensor unit 12 and the control unit 13 are supplied with electric power from a battery 3 of the digital camera.

Preferably, the display unit 11 is a bi-stable display unit, which displays a variety of setting pictures of the hand-held image-capturing device 2 in a bi-stable manner, wherein each of the variety of setting pictures includes a plurality of setting value graphs. In a preferred embodiment of the present invention, the variety of setting pictures can provide the following functions commonly used in image-capturing: setting a display picture of an operating mode, setting a display picture of ISO vale adjustment and setting a display picture of exposure compensation value. Preferably, the display unit 11 is an LCD, an electronic ink display, a plasma display or a cholesterol-type LCD. Such kinds of displays will only consume electric power during the changing process of the pictures displayed thereon. Therefore, it is capable of reducing the power consumption of a digital camera to tremendously extend, while the operation period of the digital camera is thus extended, after the digital camera is charged in one time.

The touch sensor unit 12 is installed in proximity to the display unit 11 for sensing a touch of a user. In the preferred embodiment, as shown in FIG. 2 and FIG. 3, the display unit 11 is in a circular shape and disposed on an upper side of the digital camera. Besides, the touch sensor unit 12 is circularly installed on the peripheral portion of the circular display unit 11. An instruction is received by the touch sensor unit 12, which may change the setting pictures displayed on the display unit 11 and select a setting value graph in the setting picture.

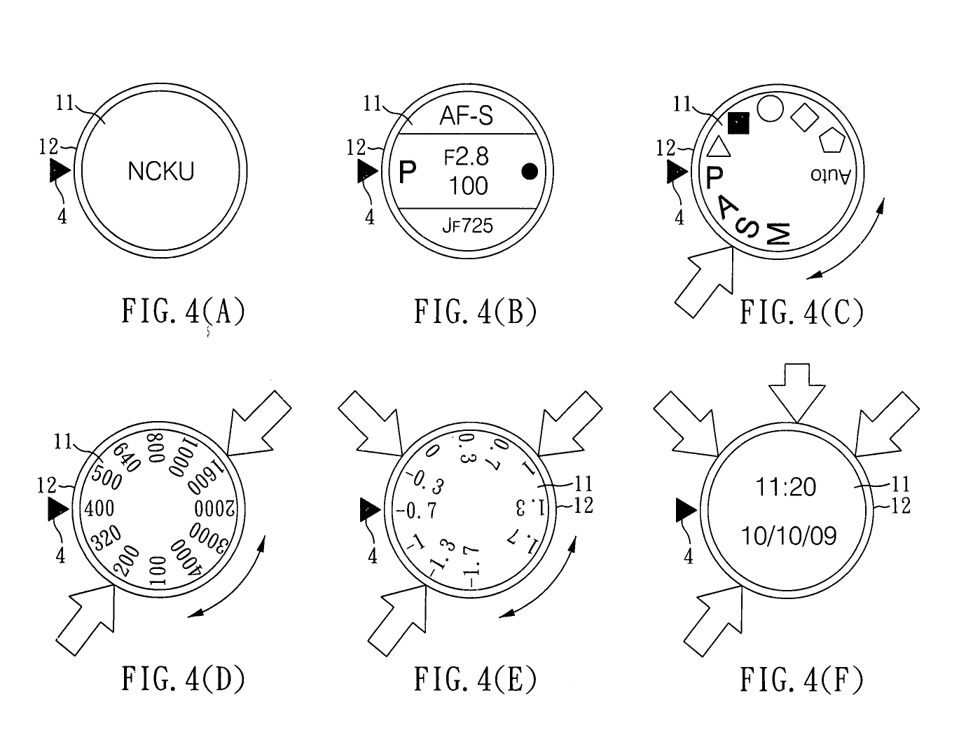

Please refer to FIG. 4(A), which displays an initial display picture on the display unit 11 of the hand-held image-capturing device 2. Since the display unit 11 is an LCD, an electronic ink display, a plasma display or a cholesterol-type LCD, the display unit 11 will not consume electric power to maintain the initial display picture. In addition, the display picture may adopt any personally characterized design, in response to the personalized need of the user, such as displaying the name and the nickname thereof, etc.

Please refer to FIG. 4(B), which displays a display picture on the display unit 11 of the hand-held image-capturing device 2 as the power is turned on. As shown in the figure, the display picture displays a system status of the hand-held image-capturing device 2. The F2.8 indication and the 100 indication of the figures indicate the aperture value and the shutter value calculated by the hand-held image-capturing device 2 in a present metering mode. In addition, the present metering mode of the hand-held image-capturing device 2 is currently in a point metering mode, which is represented by a black point at the right side of FIG. 4(B). The row displaying the black point is used for displaying the metering mode. The other metering modes include a center-weighted metering mode and a matrix metering mode, etc. Besides, the AF-S indication represents that a silent focusing mode in a high speed is current in use. The row displaying the AF-S indication is used for displaying the current in use focusing mode of the hand-held image-capturing device 2. The JF725 indication represents that the hand-held image-capturing device 2 can take 725 pictures more, with a refined JPEG file format. The alphabet P indication represents that the exposure mode, which is set by the user previously, is the Programmed Auto mode.

As the touch sensor unit 12 senses a one-point touch by a finger of the user, which is represented by the hollow arrow of FIG. 4(C), the control unit 13 drives the display unit 11 to display a first setting picture of an operating mode, wherein the first setting picture includes a plurality of setting value graphs, such as “P”, “A”, “S”, and “M”, for user's selection. The “P” indication represents the Programmed Auto mode, the “A” indication represents the Aperture-Priority Auto mode, the “S” indication represents the Shutter-Priority Auto mode, and the “M” indication represents the Manual mode. Besides, various solid geographical graphs having different gray-levels of FIG. 4(C) represent respective exposure modes, such as a fast-moving mode, a portrait photo mode, a night scene mode and other kinds of modes. As such, the user may make the plurality of setting value graphs displayed on the display unit 11 to rotate synchronously, by using a finger to touch and slide over the touch sensor unit 12. Besides, the plurality of setting value graphs displayed on the display unit 11 rotates in a direction determining by the slide direction of the finger. Thus, a selected setting value graph is rotated to a position indicated by an index 4. For example, as shown in FIG. 4(C), as the user rotates the setting value graph “P” to the position indicated by the index 4, for selecting the setting value graph “P”, the control unit 13 then operates in the mode corresponding to the setting value graph “P”. As described above, the touch sensor unit 12 selects a setting value graph displayed on the display unit 11 by sensing a moving touch and the direction of movement of the moving touch, thereby achieving the effect of rotating the setting value graphs. In addition, once the touch sensor unit 12 does not sense a finger's touch of the user in a short time-interval, the display unit 11 will return to the mode of displaying the system status of the hand-held image-capturing device 2, as shown in FIG. 4(B).

As the touch sensor unit 12 senses a two-point touch by the finger(s) of the user, which is represented by the two hollow arrows of FIG. 4(D), the control unit 13 drives the display unit 11 to display a second display picture of ISO vale adjustment, wherein the second setting picture includes a plurality of setting value graphs, such as “400”, “500”, “640” and “800”, etc., for user's selection. The two-point touch represents that the touch sensor unit 12 senses a touch by two fingers of the user simultaneously, or that the touch sensor unit 12 senses two continuous touches in a short time-interval. The user may select a setting value graph displayed on the display unit 11 by sliding the touch, for rotating the selected setting value graph representing the required ISO value to a position indicated by the index 4. In this embodiment, the user rotates the setting value graph of the “400” indication to the position indicated by the index 4, for selecting an ISO value of “400”. As a result, once the user has to adjust the ISO value to other values, it is unnecessary for the user to make the camera to enter the Menu list, as what the existing models of camera in the market did. Instead, the user can adjust the ISO value to other values, by only touching the touch sensor unit 12 with the two-point touch. Then, the second setting picture will be displayed on the display unit 11, with to the ISO value ranged from 100 to 4000, for user's selection. In addition, once the touch sensor unit 12 does not sense a finger's touch of the user in a short time-interval, the display unit 11 will return to the mode of displaying the system status of the hand-held image-capturing device 2, as shown in FIG. 4(B).

As the touch sensor unit 12 senses a three-point touch by the finger(s) of the user, which is represented by the three hollow arrows of FIG. 4(E), the control unit 13 drives the display unit 11 to display a third display picture of exposure compensation value, wherein the third setting picture includes a plurality of setting value graphs, such as “−0.7”, “−0.3”, “0” and “0.3”, etc., for user's selection. The three-point touch represents that the touch sensor unit 12 senses a touch by three fingers of the user simultaneously, or that the touch sensor unit 12 senses three continuous touches in a short time-interval. The user may select a setting value graph displayed on the display unit 11 by sliding the touch, for rotating the selected setting value graph representing the required exposure compensation value to a position indicated by the index 4. In this embodiment, the user rotates the setting value graph of the “−0.7” indication to the position indicated by the index 4, for selecting an exposure compensation value “−0.7”. As a result, once the user has to adjust the exposure compensation value to other values, it is unnecessary for the user to make the camera to enter the Menu list, as what the existing models of camera in the market did. Instead, the user can adjust the exposure compensation value to other values, by only touching the touch sensor unit 12 with the three-point touch. Then, the third setting picture will be displayed on the display unit 11, with the exposure compensation value ranged from −1.7 to +1.7, for user's selection. In addition, once the touch sensor unit 12 does not sense a finger's touch of the user in a short time-interval, the display unit 11 will return to the mode of displaying the system status of the hand-held image-capturing device 2, as shown in FIG. 4(B).

Further, as the touch sensor unit 12 senses a four-point touch by the finger(s) of the user, which is represented by the four hollow arrows of FIG. 4(F), the control unit 13 drives the display unit 11 to display a display picture of current time and date. Similarly, the four-point touch represents that the touch sensor unit 12 senses a touch by four fingers of the user simultaneously, or that the touch sensor unit 12 senses four continuous touches in a short time-interval. In addition, once the touch sensor unit 12 does not sense a finger's touch of the user in a short time-interval, the display unit 11 will return to the mode of displaying the system status of the hand-held image-capturing device 2, as shown in FIG. 4(B).

Furthermore, the display unit 11 may be disposed with a backlight module, such that the interface system of an image-capturing device of the present invention can be utilized even in a dark environment.

As, described above, the interface system 1 of an image-capturing device of the present invention allows the user to adjust various exposure parameters of the above-mentioned image-capturing device quickly and intuitively. Besides, another advantage of the interface system of an image-capturing device of the present invention is that the above-mentioned display unit 11 will consume power only during the changing process of the pictures displayed thereon, it will not consume any power when displaying steady graphs or alphabets. Therefore, the operation of the interface system 1 will not consume much additional power of the battery of the image-capturing device. Further, the design of the present invention allows the top side of the camera can additionally provide a display unit for displaying the related exposure parameters, such that the user of the camera may access the related exposure parameters directly from the top side of the camera, without the need to turn on the screen disposed on the back side of the camera, while saving more power consumption. Still further, with the interface system of an image-capturing device of the present invention, the user can rapidly adjust the related exposure parameters of the camera with only one hand, which is very convenient to the user. Since the adjustments of portions of related exposure parameters are all integrated together, it may reduce the quantity of the push button and rotating wheel of the camera, thereby simplifying the interface of the camera.

Although the present invention has been explained in relation to its preferred embodiment, it is to be understood that many other possible modifications and variations can be made without departing from the spirit and scope of the invention as hereinafter claimed.

What is claimed is:

1. An interface system of an image-capturing device, set on a hand-held image-capturing device, comprising:
a display unit, for displaying a variety of setting pictures of the image-capturing device, each of the variety of setting pictures including a plurality of setting value graphs;
a touch sensor unit, installed in proximity to the display unit, for sensing a touch of a user so as to change the setting pictures of the image-capturing device displayed on the display unit, and to select a setting value graph in the setting picture; and
a control unit, connected with the display unit and the touch sensor unit, for controlling the operation of the image-capturing device.

2. The interface system of an image-capturing device as claimed in claim 1, wherein as the touch sensor unit senses a one-point touch of the user, the control unit drives the display unit to display a first setting picture including a plurality of first setting value graphs for selection; as the touch sensor unit senses a two-point touch of the user, the control unit drives the display unit to display a second setting picture including a plurality of second setting value graphs for selection; and as the touch sensor unit senses a three-point touch of the user, the control unit drives the display unit to display a third setting picture including a plurality of third setting value graphs for selection.

3. The interface system of an image-capturing device as claimed in claim 2, wherein the two-point touch represents that the touch sensor unit senses a touch by two fingers of the user simultaneously, and the three-point touch represents that the touch sensor unit senses a touch by three fingers of the user simultaneously.

4. The interface system of an image-capturing device as claimed in claim 2, wherein the two-point touch represents that the touch sensor unit senses two continuous touches in a short time-interval, and the three-point touch represents that the touch sensor unit senses three continuous touches in a short time-interval.

5. The interface system of an image-capturing device as claimed in claim 2, wherein the touch sensor unit selects the plurality of setting value graphs displayed on the display unit by sensing a moving touch and the direction of movement of the moving touch.

6. The interface system of an image-capturing device as claimed in claim 1, wherein the display unit is in a circular shape and the touch sensor unit is circularly disposed on a peripheral portion of the circular display unit.

7. The interface system of an image-capturing device as claimed in claim 1, wherein the display unit is an LCD, an electronic ink display, a plasma display or a cholesterol-type LCD.

8. The interface system of an image-capturing device as claimed in claim 2, wherein the first setting picture displayed on the display unit is a display picture of an operating mode.

9. The interface system of an image-capturing device as claimed in claim 2, wherein the second setting picture displayed on the display unit is a display picture of ISO vale adjustment.

10. The interface system of an image-capturing device as claimed in claim 2, wherein the third setting picture displayed on the display unit is a display picture of exposure compensation value.

11. The interface system of an image-capturing device as claimed in claim 1, wherein the display unit includes a backlight module.
